(19) United States
(12) Patent Application Publication
(10) Pub. No.: US 2025/0024273 A1
(43) Pub. Date: Jan. 16, 2025

(54) COMMUNICATION WITH PASSIVE WIRELESS BACKSCATTERING DEVICES

(71) Applicant: Telefonaktiebolaget LM Ericsson (publ), Stockholm (SE)

(72) Inventors: Joao VIEIRA, Hjärup (SE); Erik G. LARSSON, Linköping (SE)

(21) Appl. No.: 18/714,332

(22) PCT Filed: Dec. 3, 2021
(86) PCT No.: PCT/EP2021/084115

§ 371 Date: May 29, 2024

(51) Int. Cl. H04W 24/02; H04B 7/145; H04W 24/10; H04W 64/00

(52) U.S. Cl. CPC H04W 24/02; H04B 7/145; H04W 24/10; H04W 64/003

(57) ABSTRACT

There is provided mechanisms for communicating with passive wireless backscattering devices. A method is performed by a controller. The controller is configured to control APs in a wireless network. The method comprises partitioning the wireless network into groups of APs according to proximity indicating information of the APs. The proximity indicating information indicates how proximate the APs are relative each other. The method comprises assigning, to the APs in each of the groups, either a transmitting role or a receiving role for communicating with the passive wireless backscattering devices. At least one AP in each group is assigned the transmitting role and at least one other AP in each group is assigned the receiving role. The method comprises initiating the APs to communicate with the passive wireless backscattering devices in accordance with the assigned roles.

The project leading to this application has received funding from the European Union's Horizon 2020 research and innovation programme under grant agreement No 101013425

### TECHNICAL FIELD

Embodiments presented herein relate to a method, a controller, a computer program, and a computer program product for communicating with passive wireless backscattering devices.

### BACKGROUND

A passive wireless backscattering device, sometimes also referred to as a passive (radio) device, is a device that is capable of communicating without the need to use an active radiofrequency (RF) frontend. A passive wireless backscattering device might be without an active RF frontend, but it has an antenna whose reflection coefficient can be varied using, for example, a simple circuit that adjusts the impedance of the load connected to the antenna. By varying this impedance, the passive wireless backscattering device can affect the properties of the wave that is reflected (backscattered) when the device is illuminated by RF energy, for example by an access point (AP). Communication with a passive wireless backscattering device thus takes place by illuminating it with RF power from a transmitter antenna at an AP and having the passive wireless backscattering device modulate its antenna impedance according to a pattern that contains the information that the passive wireless backscattering device wants to transmit. The variations in the reflected (backscattered) wave are then detected by a receiving antenna at the same or other AP, and the information sent by the passive wireless backscattering device is decoded.

Utilizing passive wireless backscattering devices for communication is a promising approach towards realizing a sustainable Internet-of-Things infrastructure and can be implemented (at the passive wireless backscattering device side) using, for example, very simple and battery-free electronics. One challenge with utilizing passive wireless backscattering devices for communication is the limited range of communication. This is because of the path loss multiplication effect. Since the passive wireless backscattering device does not have an active transmitter, the backscattered signal will suffer from a path loss that equals the product of the path loss from the transmit antenna at the AP to the backscattering device and the path loss back from the backscattering device to the receive antenna at the same or other AP.

One solution to this challenge is to use APs with multiple antennas that can harvest an array gain. This is reminiscent of how a multiple-input multiple-output (MIMO) transmitter/receiver obtains an array gain in coherent, closed-loop communications. It is known to use APs in the context of communicating with a backscattering device only for monostatic setups, where the same antenna panel at the AP is used for both transmission and reception. In turn, this requires the use of full-duplex RF electronics at the APs. While such full-duplex monostatic setups are theoretically possible to build, devices capable of full-duplex MIMO communications are today very expensive and full-duplex MIMO communications is not yet a mature technology. In contrast, a bi-static MIMO reader setup, that is, an AP which uses one antenna, or antenna panel, as transmitter and a different antenna, or antenna panel, as receiver (where both antenna panels comprise multiple antennas), could be an option as this would circumvent the need for full-duplex technology. Further, in a multi-static setup, a large number of distributed panels, or APs, can be jointly used to communicate with the passive wireless backscattering devices. As for the bi-static setup, the same panel, or AP, does not act as receiver and transmitter simultaneously.

However, due to operational challenges, applying mono-static, or bi-static, state-of-the-art methods in a straightforward manner to multi-static setups would result in sub-optimal performance. These operational challenges arise when the number of panels, or APs, available to communicate with the passive wireless backscattering devices is larger than two.

Therefore, there is a need for techniques to communicate with passive wireless backscattering devices in multi-static setups.

### SUMMARY

An object of embodiments herein is to address the above issues and enable efficient communication for APs with passive wireless backscattering devices, even in multi-static setups.

According to a first aspect there is presented a method for communicating with passive wireless backscattering devices. The method is performed by a controller. The controller is configured to control APs in a wireless network. The method comprises partitioning the wireless network into groups of APs according to proximity indicating information of the APs. The proximity indicating information indicates how proximate the APs are relative each other. The method comprises assigning, to the APs in each of the groups, either a transmitting role or a receiving role for communicating with the passive wireless backscattering devices. At least one AP in each group is assigned the transmitting role and at least one other AP in each group is assigned the receiving role. The method comprises initiating the APs to communicate with the passive wireless backscattering devices in accordance with the assigned roles.

According to a second aspect there is presented a controller for communicating with passive wireless backscattering devices. The controller is configured to control APs in a wireless network. The controller comprises processing circuitry. The processing circuitry is configured to cause the controller to partition the wireless network into groups of APs according to proximity indicating information of the APs. The proximity indicating information indicates how proximate the APs are relative each other. The processing circuitry is configured to cause the controller to assign, to the APs in each of the groups, either a transmitting role or a receiving role for communicating with the passive wireless backscattering devices. At least one AP in each group is assigned the transmitting role and at least one other AP in each group is assigned the receiving role. The processing circuitry is configured to cause the controller to initiate the APs to communicate with the passive wireless backscattering devices in accordance with the assigned roles.

According to a third aspect there is presented a controller for communicating with passive wireless backscattering devices. The controller is configured to control APs in a wireless network. The controller comprises a partition module configured to partition the wireless network into groups of APs according to proximity indicating information of the APs. The proximity indicating information indicates how proximate the APs are relative each other. The controller comprises an assign module configured to assign, to the APs in each of the groups, either a transmitting role or a receiving role for communicating with the passive wireless backscattering devices. At least one AP in each group is assigned the transmitting role and at least one other AP in each group is assigned the receiving role. The controller comprises an initiate module configured to initiate the APs to communicate with the passive wireless backscattering devices in accordance with the assigned roles.

According to a fourth aspect there is presented a computer program for communicating with passive wireless backscattering devices, the computer program comprising computer program code which, when run on a controller, causes the controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient communication for APs with passive wireless backscattering devices, also in multi-static setups (compared to applying mono-static, or bi-static state-of-the-art, methods to a multi-static setup in a straightforward manner).

Advantageously, these aspects improve the performance of detecting the presence of passive wireless backscattering devices.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 and 3 are schematic diagrams illustrating a wireless network according to embodiments;

FIGS. 2 and 4 are flowcharts of methods according to embodiments;

FIG. 5 is a schematic diagram showing functional units of a controller according to an embodiment;

FIG. 6 is a schematic diagram showing functional modules of a controller according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

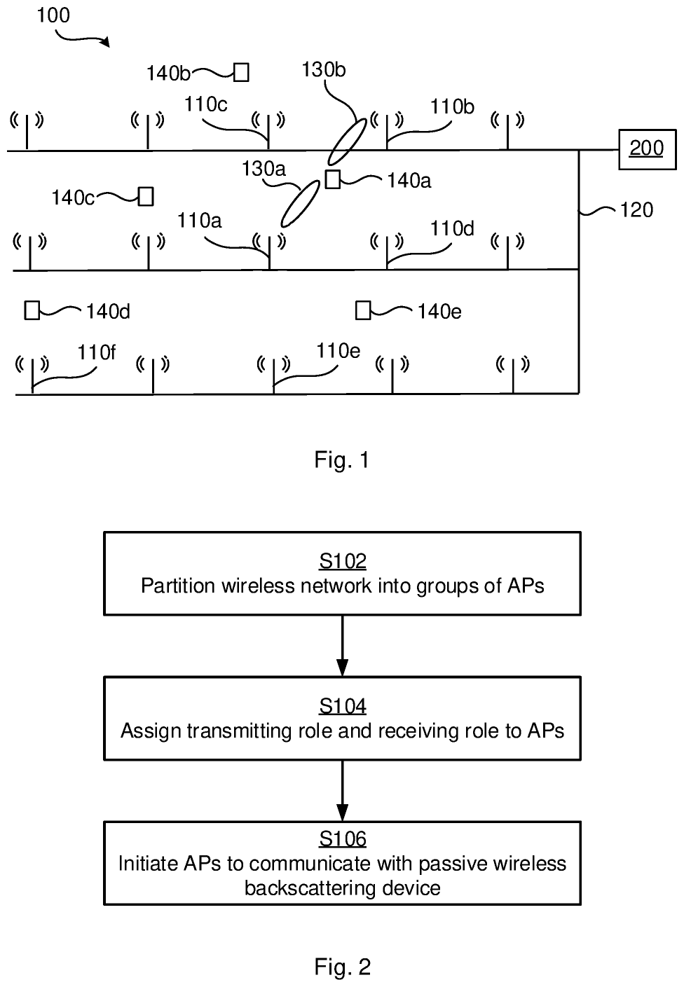

FIG. 1 is a schematic diagram illustrating a wireless network 100 where embodiments presented herein can be applied. The wireless network 100 comprises APs, six of which are identified at reference numerals 110a, 110b, 110c, 110d, 110e, 110f. In this respect, the herein disclosed embodiments are not limited to any particular number of APs 110a:110f. Each AP 110a:110f could be a (radio) access network node, radio base station, base transceiver station, node B (NB), evolved node B (eNB), gNB, integrated access and backhaul (IAB) node, or the like. The APs 110a:110f are operatively connected over interfaces 120 to a central controller 200, which could represent a node in a core network. The APs 110a:110f are configured to communicate with passive wireless backscattering devices 140a, 140b, 140c, 140d, 140e. In this respect, the herein disclosed embodiments are not limited to any particular number of passive wireless backscattering devices 140a: 140e. The APs 110a:110f are configured for wireless communication with the passive wireless backscattering devices 140a: 140e. In some examples, the APs 110a: 110f use beamforming for this communication, as represented by beams 130a, 130b. The signals as backscattered by any of the passive wireless backscattering devices 140a: 140e might be received by several APs 110a:110f, and the received signals at these APs 110a:110f are combined according to some post-processing process known in the art. The wireless network 100 thus represents a multi-static setup. As noted above, there is a need for techniques to communicate with passive wireless backscattering devices in multi-static setups.

The herein disclosed embodiments address new operational challenges related to the communication with passive wireless backscattering devices 140a: 140e in multi-static setups. Specifically, the herein disclosed embodiments address the problems of 1) of panel selection, i.e. which (group of) APs 110a:110f should be selected at a given instant to attempt communication with the passive wireless backscattering devices 140a: 140e, 2) transmit and receive selection, i.e. which of the selected APs 110a:110f should act as transmitters and which should act as receivers, and 3) which signaling techniques should be used in case multiple APs 110a:110f in each group are selected as transmitters.

The embodiments disclosed herein in particular relate to mechanisms for communicating with passive wireless backscattering devices 140a: 140e. In order to obtain such mechanisms, there is provided a controller 200, a method performed by the controller 200 and a computer program product comprising code, for example in the form of a computer program, that when run on a controller 200, causes the controller 200 to perform the method.

FIG. 2 is a flowchart illustrating embodiments of methods for communicating with passive wireless backscattering devices 140a: 140e. The methods are performed by the controller 200. The controller 200 is configured to control APs 110a:110f in a wireless network 100. The methods are advantageously provided as computer programs 720.

S102: The controller 200 partitions the wireless network 100 into groups of APs 110a: 110f according to proximity indicating information of the APs 110a:110f. The proximity indicating information indicates how proximate the APs 110a:110f are relative each other. Further aspect of the partitioning will be disclosed below. Examples of proximity indicating information and how the controller 200 might obtain the proximity indicating information will be provided below.

S104: The controller 200 assigns, to the APs 110a:110f in each of the groups, either a transmitting role or a receiving role for communicating with the passive wireless backscattering devices 140a: 140e. At least one AP in each group is assigned the transmitting role and at least one other AP in each group is assigned the receiving role. Further aspects of the assigning will be disclosed below.

S106: The controller 200 initiates the APs 110a:110f to communicate with the passive wireless backscattering devices 140a: 140e in accordance with the assigned roles. Further aspect of the initiating will be disclosed below.

Embodiments relating to further details of communicating with passive wireless backscattering devices 140a: 140e as performed by the controller 200 will now be disclosed.

In some aspects, the method is executed for a multi-static setup of APs 110a:110f. In particular, in some embodiments, there are at least three APs 110a:110f in the wireless network 100 that are to be partitioned into groups of APs 110a:110f. This implies that the method is applied to a multi-static setup of APs 110a: 110f. In some embodiments, a group of APs comprises at least three APs.

Aspects of the proximity indicating information will be disclosed next.

In some aspects, the proximity indicating information is based on a received power-related metric, such as received signal strength (RSS), path gain, or channel quality. Thus, in some embodiments, the proximity indicating information relates to received power for wireless communication between the APs 110a:110f.

There could be different ways for the controller 200 to obtain the proximity indicating information. In some embodiments, the proximity indicating information is based on pairwise over-the-air measurements between the APs 110a:110f. The proximity indicating information might be provided in terms of explicit or implicit information of where the APs 110a:110f are located. That is, the proximity indicating information might relate to geographical locations for each of the APs 110a:110f.

The proximity indicating information might be collected as entries in a connectivity matrix or adjacency matrix. The entries might be a measured RSS value, received signal strength indicator (RSSI) values, estimated path-gain values or values that are a function of these parameters. Further, the entries could be geographical distance values or a function of these. Further, the entries might be real-valued or binary-valued. Hence, in some embodiments, the proximity indicating information is provided in terms of entries in a connectivity matrix for the APs 110a:110f. The proximity indicating information, whether or not it is collected as entries in a connectivity matrix or adjacency matrix, might be stored at a central storage.

In general terms, a connectivity matrix C might describe to what extent different pairs of APs 110a:110f can hear/communicate with each other. The connectivity matrix C is of dimension L×L, where L is the number of APs 110a:110f in the wireless network 100. In some examples, the entry, or element, (i, j) of C represents an estimated path gain value or RSS value between AP i and AP j. In some, C has binary entries (0 or 1), where “1” indicates that APs i and j can reliably communicate with each other, and “0” indicates that they cannot. Each binary entry can be obtained by comparing the corresponding estimated path gain value with a threshold. In most such examples the connectivity matrix C is symmetric. In case the connectivity matrix only contains binary entries, connectivity matrix C can be thought of an adjacency matrix representing a connectivity graph.

As disclosed above, the entries of C might be obtained by pairwise measurements among pairs of APs 110a:110f. For example, enumerate all L(L−1)/2 combinations (i, j) of APs 110a:110f: (1,2), (1,3), . . . , (1, L), (2,1), (2,3) . . . , (2, L), . . . , (L−1, L). For each of these combinations (i, j), in order to obtain the (i, j):th element of C, have a first AP (i) transmit a pre-determined/reference signal and have the second AP (j) receive this signal and measure its strength, or the path gain of the radio channel.

This can mathematically be expressed as:

$${y}_{j , i}^{q} = {h}_{j , i}^{q} {Φ}_{j , i}^{q} + {n}_{j , i}^{q} , \qquad ( 1 )$$

where y_{j,i}^{q} is the received signal at the second AP (j) when the first AP (i) transmits a reference signal in the q:th subcarrier, h_{j,i}^{q} is the radio channel at subcarrier q between AP (j) and AP (i), Φ_{j,i}^{q} is the transmitted reference signal, and n_{j,i}^{q} is additive noise. The pilot signal Φ_{j,i}^{q} may be a scalar or a row vector, depending on whether more than one channel use (e.g. time instant) is used to transmit the pilot. Assuming such reference signal(s) transmission to be unit-energy, i.e. Φ_{j,i}^{q} (Φ_{j,i}^{q})^{H}=1, the path gain, or average received signal energy per subcarrier, which is relevant for the computation of the connectivity matrix C, may be estimated using a sample average, such as:

$${P}_{j , i} = \frac{1}{Q} {\sum }_{q = 1}^{Q} {‖ {y}_{j , i}^{q} ‖}^{2} , \qquad ( 2 )$$

where Q is the number of subcarriers. Other estimation criteria, such as a Minimum Mean-Squared Error (MMSE) estimation criterion, which accounts for the noise in the estimation, may also be used. Such a path gain estimate defines the entry (j, i) of the connectivity matrix, namely, C_{j,i}=P_{j,i}, where C_{j,i} is the (j, i) entry of C. The computed path gain P_{j,i} may be compared against a pre-defined threshold in order to make a binary decision in case the connectivity matrix C is composed of binary entries, as disclosed above.

In some examples, the pairwise measurements between the APs 110a:110f (that are used to compute C) are performed in a calibration step that is carried out when the system is initially configured, or when the APs 110a:110f are installed. In some examples, these pairwise measurements are repeated with a given frequency of occurrence. For example, the frequency of occurrence for repeating the measurements might be inversely proportional to the time during which large-scale properties (such as path loss) of the radio channel between the APs 110a:110f remain substantially constant. This can be inferred on-the-fly, for example, by first executing pairwise measurements rounds at a high frequency of occurrence and then adjusting the frequency of occurrence of the repetitions to a lower value if the large-scale properties of the measurement set did not change significantly across sub-sequent measurement rounds.

Aspects of how the controller 200 might partition the wireless network 100 into groups of APs 110a:110f according to proximity indicating information of the APs 110a:110f will be disclosed next. For notation purposes, assume that one or more groups G₁, G₂, . . . of APs 110a:110f are determined in S102. Each such group, say the k:th group, then consists of Lₖ APs.

As disclosed above, the APs 110a:110f within a group will in S106 be initiated to communicate with passive wireless backscattering devices 140a: 140e in accordance with assigned roles. It is thereby desirable that the APs within any given group can reliably communicate with each another, in other words, that their associated entries in the connectivity matrix C are large (or at least non-zero for the binary-valued case). If the location of the passive wireless backscattering devices 140a: 140e are unknown, the controller 200 might try to communicate with the passive wireless backscattering devices 140a: 140e using multiple different groups of APs 110a:110f. One objective of assigning each of the APs 110a:110f to one of the groups of APs 110a:110f is therefore to create groups within which most APs 110a:110f can reliably communicate with each another, since if this is the case, and the passive wireless backscattering devices 140a: 140e are located within the range of most APs within the group, then communication with the passive wireless backscattering devices 140a: 140e is likely to succeed.

In some aspects, the partitioning is based on constructing an undirected graph, with L nodes, where the l:th node corresponds to the l:th AP, from the connectivity matrix C. Hence, in some embodiments, the wireless network 100 is partitioned into the groups of APs 110a:110f in accordance with an undirected graph constructed from the connectivity matrix. In case C is binary-valued, the graph can be construed using C as its adjacency matrix. In case C is real-valued, then an edge between nodes i and j in the graph can be construed for element (i, j) in case the value of this entry exceeds a pre-determined threshold value. Groups of APs 110a:110f can then be created based on how isolated or interconnected, respectively, different APs 110a:110f are to each other.

In some aspects, the partitioning is performed using a community detection clustering algorithm, where each community found by the algorithm is used to define a group of APs 110a:110f. In particular, in some embodiments, a community detection algorithm is used to partition the wireless network 100 into the groups, where the community detection algorithm takes the proximity indicating information as input, and where communities found by the community detection algorithm define the groups. Examples of community detection algorithms are the Girvan-Newman algorithm, spectral modularity maximization using repeated bisection, and the Louvain algorithm. Alternatively, a community detection algorithm that identifies overlapping communities can be used. Yet alternatively, another heuristic algorithm might be used to partition the wireless network 100 into the groups. Here, a pre-determined number, say L′, of APs 110a:110f are identified in a first step as central nodes by computing for each of the L APs 110a:110f a centrality metric, and identifying the L′ APs 110a:110f, say i₁, . . . , i_{L}, with the highest metric. Examples of centrality metrics that can be used are betweenness centrality, closeness centrality, Katz centrality or PageRank centrality. In a second step, for each of the L′ APs 110a:110f with the highest centrality metric, l=1, . . . , L′, a group Gₗ is formed that comprises node iₗ together with its neighbors in the graph. Second- or higher-order neighbors could also be included. In other aspects, for a given number of groups of APs 110a:110f, a brute force search can be performed over the connectivity matrix to perform the partitioning (i.e., to determine how the given number of groups of APs 110a:110f are to be populated). In some examples, the algorithm used to perform the partitioning automatically determines how many groups to create. In some examples, the number of groups to create is controlled by setting a stopping criterion for the algorithm.

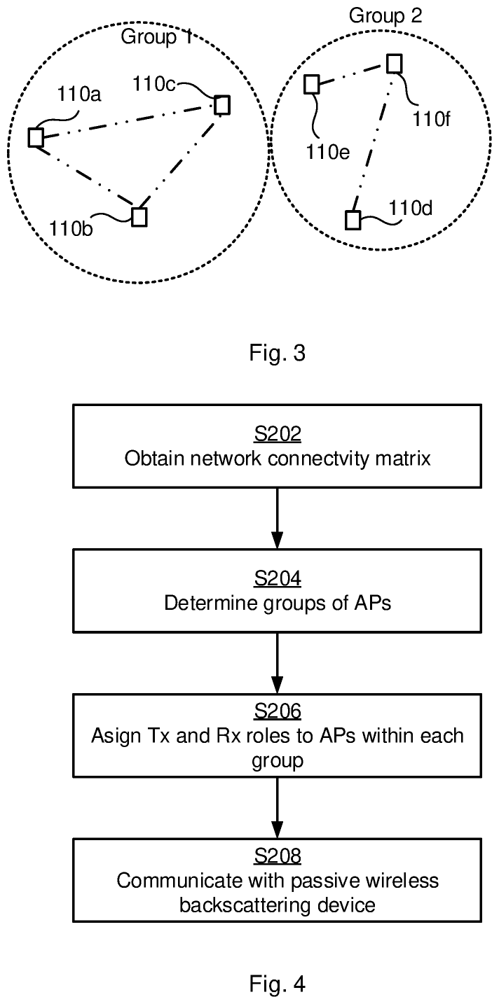

Reference is here made to Table 1 that illustrates a connectivity matrix for a case of six APs 110a:110f. The corresponding wireless network 100 with the six APs 110a:110f and a possible result of grouping the APs 110a:110f into two groups is shown in FIG. 3. In the table, the diagonal elements of C have no operational meaning, since an AP operating in half-duplex mode cannot act as transmitter and receiver simultaneously, and are arbitrarily set to 1 in the example. In the figure, dash-dotted-dotted lines indicate which APs 110a:110f that can reliably communicate with each another; for example, AP 110e is assumed to be able to reliably communicate with AP 110f but not with AP 110d, etc.

TABLE 1
Example of a connectivity matrix

| AP | 110a | 110b | 110c | 110d | 110e | 110f |
|---|---|---|---|---|---|---|
| 110a | 1 | 1 | 1 | 0 | 0 | 0 |
| 110b | 1 | 1 | 1 | 0 | 0 | 0 |
| 110c | 1 | 1 | 1 | 0 | 0 | 0 |
| 110d | 0 | 0 | 0 | 1 | 0 | 1 |
| 110e | 0 | 0 | 0 | 0 | 1 | 1 |
| 110f | 0 | 0 | 0 | 1 | 1 | 1 |

Aspects of how the controller 200 might assigns either a transmitting role or a receiving role to the APs 110a:110f in each of the groups for communicating with the passive wireless backscattering devices 140a: 140e will be disclosed next.

In general terms, the assignment of transmitting roles and receiving roles is performed on a per-group basis, for all groups G₁, G₂, . . . . That is, for AP group i, first, a subset of the APs in Gᵢ are designated as transmitters (i.e., taking the transmitting role) and a non-overlapping subset of APs are designated as receivers (i.e., taking the receiving role). Denote the number of APs in Gᵢ as Nᵢ. Let Tᵢ, with 1≤Tᵢ≤Nᵢ−1, be the number of APs designated as transmitters, and Rᵢ, with 1≤Rᵢ≤Nᵢ−1, be the number of APs designated as receivers. Furthermore, let tᵢ₁, . . . , t_{iT}_{ᵢ}, denote the indices of the APs appointed as transmitters and rᵢ₁, . . . , r_{iR}_{ᵢ} denote the corresponding indices of receiving APs. Consequently, this yields the partition

$${G}_{i} = \{ ( {t}_{i 1} , … , {t}_{i {T}_{i}} ) , … , ( {r}_{i 1} , … , {r}_{i {R}_{i}} ) \} .$$

In some aspects Tᵢ+Rᵢ=Nᵢ. That is, each AP 110a:110f is assigned either the transmitting role or the receiving role. One advantage of having more than one AP assigned to the transmitting role and/or more than one AP assigned to the receiving role in each group is to increase the order of diversity to fading or blocking.

Further, in some aspects, there are as many transmitters as there are receivers. That is, in some embodiments, the roles are assigned, in each of the groups, to have as many APs 110a:110f assigned to the transmitting role as assigned to the receiving role. This could advantageously maximize the diversity order in a group of APs where the path gains between all AP pairs in the group are similarly favorable. The assignment of roles can thus be performed with an objective to optimize a performance metric of the link between the APs in each group and the passive wireless backscattering devices 140a: 140e. In some embodiments, the roles are therefore assigned, in each of the groups, to optimize a communication metric for communication between the APs 110a:110f and the passive wireless backscattering devices 140a: 140e. Here, the diversity order that can be extracted is Tᵢ×Rᵢ which is maximized (for a given total number of APs in per group, i.e., Tᵢ+Rᵢ) when Tᵢ=Rᵢ. Thus, in one embodiment, Tᵢ=Rᵢ if Nᵢ is an even number, or Tᵢ=Rᵢ±1 if Nᵢ is an odd number. It is thus noted that if the total number of APs 110a:110f is odd, then there cannot be exactly as many transmitters as receivers (if all APs in the group are assigned either a transmitting role or a receiving role). Therefore, in some embodiments, the communication metric pertains to diversity order of a radio propagation channel between the APs 110a:110f and the passive wireless backscattering devices 140a: 140e.

In some aspects, the assignment of roles is performed based on the entries of sub-matrices of the connectivity matrix. Hence, each group of APs 110a:110f might correspond to a respective sub-matrix of the connectivity matrix, and the roles for a given group of APs 110a:110f are assigned as a function of entries of the sub-matrix for said given group of APs 110a:110f. This can be used to maximize diversity regardless of whether the path gains between all AP pairs in the group are similarly favorable or not. An example algorithm that is repeated for each AP group i is disclosed and exemplified next in conjunction with continued reference to FIG. 3.

Step 1: The controller 200 computes the largest number of transmit/receive favorable links which exist when one of the APs in the group acts as transmitter and all remaining APs in the group act as receivers. Denote this number by f₁. For example, in the case of Group 2 of FIG. 3 (with respective connectivity sub-matrix being the second diagonal block in Table 1, i.e., the bottom-right 3-by-3 sub-table of Table 1), two transmit/receive favorable links exist if AP 110f acts as transmitter but only one transmit/receive favorable link exist if AP 110d or AP 110e acts as the transmitter. Thus, f₁=2.

Step 2: Recompute fₙ with n APs as transmitters (and Nᵢ−n APs as receivers), with 2≤n≤Nᵢ−1.

Step 3: Select the Tᵢ transmitting APs and Rᵢ receiving APs according to the transmit/receive configuration which achieved max (f₁, . . . , f_{N}_{ᵢ}−1).

Note that max (f₁, . . . , f_{N}_{ᵢ}₋₁) can be seen as the maximum diversity order which can be extracted from the group, and which is achieved by the algorithm above.

In some aspects, multiple partitions are determined for each group. Each such partition could then selectively be applied at different points in time. Particularly, in some embodiments, the controller 200 configures the APs 110a:110f to switch between the transmitting role and the receiving role and vice versa within each of the groups between two consecutive communication instances. The process of trying new partitions can be carried out until a predetermined stopping criterion is satisfied, for example, until communication with the device succeeds (at some predetermined level of quality of service), or until a predetermined number of attempts has been performed.

Aspects of how the controller 200 might initiate the APs 110a:110f to communicate with the passive wireless backscattering devices 140a: 140e will be disclosed next.

For each group Gᵢ for which a partition Gᵢ={(tᵢ₁, . . . , t_{iT}_{ᵢ}), . . . , (rᵢ₁, . . . , r_{iR}_{ᵢ})} into transmitting and receiving APs has been determined, an access attempt is made. In some aspects, the Tᵢ transmitting APs jointly send a pre-determined matrix-valued signal, say 0, with the two dimensions of the matrix representing time and antenna index, respectively. Hence, in some embodiments, for each of the groups of APs 110a:110f, the APs 110a:110f assigned the transmitting role are instructed by the controller 200 to jointly transmit a matrix-valued signal. In some aspects, the signal matrix transmitted by the transmitting APs 110a:110f of a group is constructed from the rows of a Hadamard matrix, or the rows of an orthogonal-space time block code. That is, the matrix-valued signal might be defined by rows of a Hadamard matrix, or rows of an orthogonal-space time block code.

Consider the case of single-antenna APs 110a:110f. At a given subcarrier, or physical resource block (PRB), the transmitted matrix-valued signal θ is then of dimension Tᵢ×T where T represents the number of channel uses (e.g. time instances) used for the transmission and the k:th row of θ contains the signal sent by AP k. In some examples, the rows of θ are mutually orthogonal, which can be achieved by selecting, for example the rows of a Hadamard matrix, or the rows of an orthogonal-space time block code (composed of arbitrary symbols). In some examples, —0 is a diagonal or a permutation matrix, in which case the different APs (tᵢ₁, . . . , t_{iT}_{ᵢ}) take turn in transmitting. Such diversity-based signaling techniques can be justified in the absence of channel state information (CSI) at the transmitter, which is common when communicating with passive wireless backscattering devices 140a: 140e.

In some aspects, distinct groups of APs 110a:110f perform the above operations in parallel, for example using orthogonal time/frequency/code resources. In particular, in some embodiments the wireless network 100 is partitioned into at least two groups of APs 110a:110f, and the controller 200 configures the APs 110a:110f in one of the at least two groups of APs 110a:110f to communicate with the passive wireless backscattering devices 140a: 140e independently of the APs 110a:110f in any other of the at least two groups of APs 110a:110f. That is, in some embodiments, the controller 200 configures the APs 110a:110f in each group of APs 110a: 110f to communicate with the passive wireless backscattering devices 140a: 140e using distinct orthogonal signaling resources. Thus the time/frequency/code resources used by APs in group Gᵢ for communicating with passive wireless backscattering devices 140a: 140e remain idle for the APs of all other groups {Gₙ}_{n≠i}. In other aspects, when the APs in group Gᵢ attempt to communicate with passive wireless backscattering devices 140a: 140e, some APs of the remaining groups {Gₙ}_{n≠i}, switch to receiving mode and attempt to receive the signals from the same passive wireless backscattering devices 140a: 140e. Assume that the wireless network 100 is partitioned into at least two groups of APs 110a:110f. Then, in some embodiments, the controller 200 configures the APs 110a:110f such that, when at least one of the APs 110a:110f in one of the at least two groups of APs 110a:110f is communicating with the passive wireless backscattering devices 140a: 140e in the transmitting role, all APs 110a:110f in at least one other of the at least two groups of APs 110a:110f are communicating with the passive wireless backscattering devices 140a: 140e in the receiving role. This will not disturb the communication within the group of APs in Gᵢ and may provide extra received signals to detect the passive wireless backscattering devices 140a: 140e. In some aspects, distinct groups of APs which are well (spatially) isolated from each other, e.g. G₁ and G₂ in the example of FIG. 3 (where G₁ is short for Group 1 and G₂ is short for Group 2), attempt to communicate with the passive wireless backscattering devices 140a: 140e in non-orthogonal time/frequency resources. Hence, in some embodiments, the controller 200 configures the APs 110a:110f in each group of APs 110a:110f to communicate with the passive wireless backscattering devices 140a: 140e using distinct non-orthogonal signaling resources. For example, if the computed connectivity matrix C yields no (or just few) link(s) between the transmitter APs of G₁ and the receiver APs of G₂, as well as no (or just a few) link(s) between the transmitter APs of G₂ and the receiver APs of G₁, the two groups G₁ and G₂ are well isolated from each other, and thus it can be expected that the signals transmitted by APs in one of these groups are not heard by the APs selected as receivers of the other group.

Consider now the case of multiple-antenna APs 110a:110f. This provides the possibility of beamforming, or other types of precoding, to be applied at the APs 110a:110f.

In some aspects, virtual beamformers are formed at the APs 110a:110f based on the effective path gain. In particular, in some embodiments, the controller 200 configures each of the APs 110a:110f to communicate using transmit beams 130a, 130b and receive beams 130a, 130b, and the transmit beams 130a, 130b and the receive beams 130a, 130b are determined based on measurements of signals for sounding communication between the APs 110a:110f, as backscattered by the passive wireless backscattering devices 140a: 140e. In further detail, for each combination of APs (i, j), in order to obtain the (i, j):th element of the connectivity matrix C, a first AP (i) transmits a pre-determined signal and a second AP (j) receives this signal and measures its strength, or the resulting path gain. In some examples, each antenna element at AP (i) sends mutually orthogonal waveforms. In some examples, the antennas of AP (i) send waveforms that are determined based on prior knowledge of the radio channel from AP (i) to AP (j) (e.g. beamformed towards pre-determined directions). In some examples, the overall path gain, or RSS, is estimated from the received signals at all receiving antennas. For example, the overall path gain, RSS, might be estimated by averaging the path gains computed for all sounded antenna pairs, or beams. In some examples, an effective path gain is computed from the received signals at all receiving antennas. From such received signals, transmit and receive virtual beamformers can be computed, and an effective path gain which takes into account such virtual transmit and receive beamformers, together with the radio channel, can be computed. During operation, i.e., when the controller 200 has initiated the APs 110a:110f to communicate with the passive wireless backscattering devices 140a: 140e, AP group Gᵢ cycles among the transmitting APs (tᵢ₁, . . . , t_{iT}_{ᵢ}) and each AP transmits a set of waveforms from each of its antennas. Consider, for example, that it is AP (l):s turn to transmit and let Mₗ be the number of antennas of this AP. Then AP (l) may send orthogonal waveforms from each of its antennas, or it may send waveforms determined based on prior knowledge of the environment (e.g. beamformed towards pre-determined directions). In another example, the APs (tᵢ₁, . . . , t_{iT}_{ᵢ}) jointly transmit from the (in total) Mᵢ₁+ . . . +M_{iT}_{ᵢ} antennas. These antennas might collectively transmit orthogonal waveforms (which typically need to have a length of at least Mᵢ₁+ . . . +M_{iT}_{ᵢ} samples), but other choices of waveforms are also possible. For example, the waveforms may be constructed by taking the rows of a Hadamard matrix, or the rows of an orthogonal space-time block code.

In some aspects, a grid-of-beams 130a, 130b is used, and combinations of transmit and receive beam pairs are sounded; either all pairs or only those pairs of APs that correspond to non-zero entries in the connectivity matrix. In particular, in some embodiments, each of the APs 110a:110f is configured to communicate using transmit beams 130a, 130b and receive beams 130a, 130b defined by a grid-of-beams 130a, 130b, and the controller 200 configures the APs 110a:110f to communicate with the passive wireless backscattering devices 140a: 140e by sounding different combinations of pairs of the transmit beams 130a, 130b and the receive beams 130a, 130b. In further detail, for the pair of APs (i, j), all combinations of transmit and receive beam pairs might be sounded. The path gain, or RSS, associated with the strongest beam pair is stored in the (i, j):th element of C. Alternatively, the mean path gain, or RSS, across the sounded beam pairs may also be stored. During operation, i.e., when the controller 200 has initiated the APs 110a:110f to communicate with the passive wireless backscattering devices 140a: 140e, each AP group Gᵢ cycles among the possible pairs of transmitting APs (tᵢ₁, . . . , t_{iT}_{ᵢ}) and receiving APs (rᵢ₁, . . . , r_{iT}_{ᵢ}). For each pair, all combinations of transmit beam and receive beams might be cycled through. For each transmit and receive beam combination, and for each pair of APs in the group, communication with the passive wireless backscattering devices 140a: 140e can then be attempted. In other examples, rather than considering all pairs of transmitting/receiving APs in a group, only pairs of transmitting and receiving AP within the group for which the corresponding entry in the connectivity matrix C is non-zero are used.

During operation, i.e., when the controller 200 has initiated the APs 110a:110f to communicate with the passive wireless backscattering devices 140a: 140e, some of the APs (tᵢ₁, . . . , t_{iT}_{ᵢ}) transmit and some of the APs (rᵢ₁, . . . , r_{iR}_{ᵢ}) receive. Simultaneously to this, the passive wireless backscattering devices 140a: 140e send information by configuring the load (impedance) of its antenna according to a pattern {γ₁, . . . , γ_{L}}. For example, the pattern may represent a sequence of binary symbols, which may be implemented via 180 degrees phase shifts at the antenna load side. The pattern selected by each of the passive wireless backscattering devices 140a:140e generally corresponds to a respective information sequence. All entries of the pattern {γ₁, . . . , γ_{L}} may be a function of information bits, and thus the pattern may be seen as a code that maps a string of bits to a sequence of antenna loads. The electromagnetic signals reflected at the antennas of the passive wireless backscattering devices 140a: 140e will experience a varying reflection coefficient characterized by the above pattern {γ₁, . . . , γ_{L}}, and such pattern will be present in the received signals of the receiving APs (if reliable channel propagation paths between the antennas of the passive wireless backscattering devices 140a: 140e and the antennas of the receiving APs exist).

Each of the passive wireless backscattering devices 140a: 140e may change its impedance over a much slower time-scale than the transmission of the matrix-valued signal θ. One motivation for this mode of operation is that the passive wireless backscattering devices 140a: 140e might not be accurately time-synchronized with the APs 110a:110f, and thus some redundancy in the received signals may benefit the communication performance.

The receiving APs may decode the information bits conveyed by the passive wireless backscattering devices 140a: 140e via proprietary techniques. One non-limiting example of how the receiving APs may decode the information bits will be disclosed next. The received blocks {Y₁, . . . , Y_{Z}} are obtained, where for each block, the rows index represents antenna index and the columns represent time. The APs 110a:110f, or the controller 200, may then compute:

$${\sum }_{l = 1}^{Z} {‖ {γ}_{l}^{*} {Y}_{l} ‖}^{2}$$

and compare the result to a threshold. If the result exceeds the threshold, a signal from one of the backscattering devices 140a: 140e is detected, otherwise not. Channel invariance is assumed during the Z epochs.

The pattern applied at the backscattering devices 140a: 140e might be selected to have 1) good signal detection properties and 2) favorable implementation properties for impedance matching. One example is maximum-length pseudo-noise sequences which 1) have autocorrelation functions with a single peak and large peak-to-sidelobe ratio, and 2) can be implemented by alternating between two distinct phase shifts.

One embodiments of a method for communicating with passive wireless backscattering devices 140a: 140e as performed by the controller 200 based on at least some of the above disclosed embodiments, aspects, and examples will be disclosed next with reference to the flowchart of FIG. 4.

S202: The APs 110a:110f signal towards each other. One objective of this is for the controller 200 to obtain a graph of the network which, to some extent, represents which pairs of APs 110a:110f can reliably communicate with each other. The graph may be represented by a network connectivity matrix, or adjacency matrix.

S204: The controller 200 determines groups of APs based on the graph obtained in step 201.

S206: The controller 200, for each group of APs, selects a subset of APs as transmitters (Tx) and another subset of APs as receivers (Rx).

S208: The controller 200 initiates the APs 110a:110f to communicate with the passive wireless backscattering devices 140a: 140e.

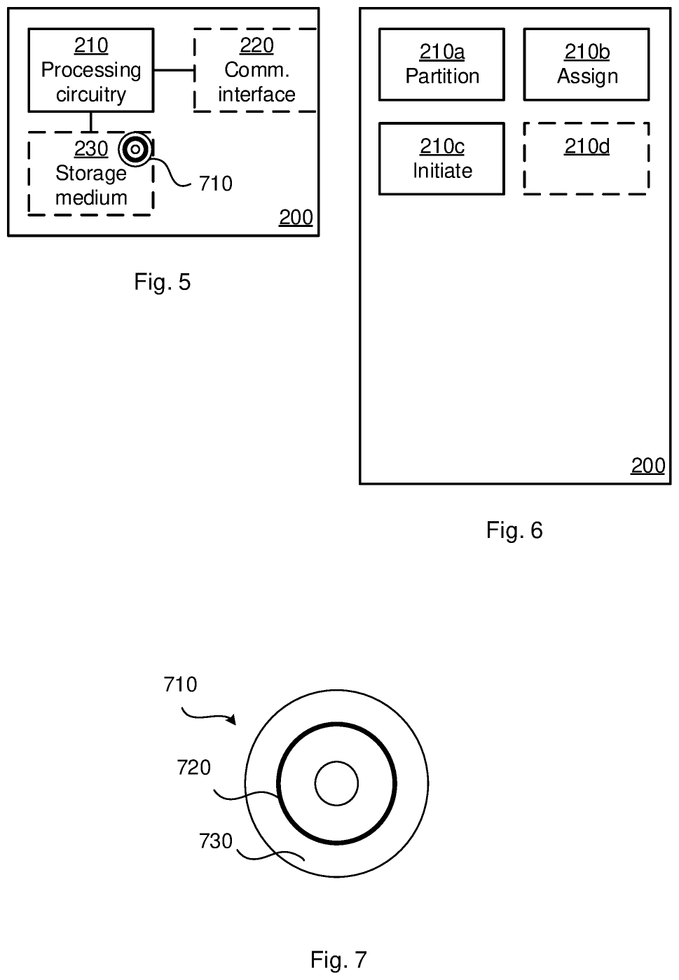

FIG. 5 schematically illustrates, in terms of a number of functional units, the components of a controller 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller 200 to perform a set of operations, or steps, as disclosed above. For example, the storage medium 230 may store the set of operations, and the processing circuitry 210 may be configured to retrieve the set of operations from the storage medium 230 to cause the controller 200 to perform the set of operations. The set of operations may be provided as a set of executable instructions.

Thus, the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller 200 may further comprise a communications interface 220 at least configured for communications with other entities, functions, nodes, and devices in the wireless network 100, such as at least the APs 110a:110f. As such the communications interface 220 may comprise one or more transmitters and receivers, comprising analogue and digital components. The processing circuitry 210 controls the general operation of the controller 200 e.g. by sending data and control signals to the communications interface 220 and the storage medium 230, by receiving data and reports from the communications interface 220, and by retrieving data and instructions from the storage medium 230. Other components, as well as the related functionality, of the controller 200 are omitted in order not to obscure the concepts presented herein.

FIG. 6 schematically illustrates, in terms of a number of functional modules, the components of a controller 200 according to an embodiment. The controller 200 of FIG. 6 comprises a number of functional modules; a partition module 210a configured to perform step S102, an assign module 210b configured to perform step S104, and an initiate module 210c configured to perform step S106. The controller 200 of FIG. 6 may further comprise a number of optional functional modules, as represented by functional module 210d. In general terms, each functional module 210a:210d may in one embodiment be implemented only in hardware and in another embodiment with the help of software, i.e., the latter embodiment having computer program instructions stored on the storage medium 230 which when run on the processing circuitry makes the controller 200 perform the corresponding steps mentioned above in conjunction with FIGS. 2 and 4. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein.

The controller 200 may be provided as a standalone device or as a part of at least one further device. For example, the controller 200 may be provided in a node of the radio access network or in a node of the core network. Alternatively, functionality of the controller 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the APs 110a:110f than instructions that are not required to be performed in real time. Thus, a first portion of the instructions performed by the controller 200 may be executed in a first device, and a second portion of the of the instructions performed by the controller 200 may be executed in a second device; the herein disclosed embodiments are not limited to any particular number of devices on which the instructions performed by the controller 200 may be executed. Hence, the methods according to the herein disclosed embodiments are suitable to be performed by a controller 200 residing in a cloud computational environment. Therefore, although a single processing circuitry 210 is illustrated in FIG. 5 the processing circuitry 210 may be distributed among a plurality of devices, or nodes. The same applies to the functional modules 210a:210d of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for communicating with passive wireless backscattering devices, the method being performed by a controller, the controller being configured to control access points, APs, in a wireless network, the method comprising:
partitioning the wireless network into groups of APs according to proximity indicating information of the APs, the proximity indicating information indicating how proximate the APs are relative each other;
assigning, to the APs in each of the groups, either a transmitting role or a receiving role for communicating with the passive wireless backscattering devices, at least one AP in each group being assigned the transmitting role and at least one other AP in each group is assigned the receiving role; and
initiating the APs to communicate with the passive wireless backscattering devices in accordance with the assigned roles.

2. The method according to claim 1, wherein the proximity indicating information relates to received power for wireless communication between the APs.

3. The method according to claim 1, wherein the proximity indicating information is based on pairwise over-the-air measurements between the APs.

4. The method according to claim 1, wherein the proximity indicating information relates to geographical locations for each of the APs.

5. The method according to claim 1, wherein the proximity indicating information is provided in terms of entries in a connectivity matrix for the APs.

6. The method according to claim 1, wherein a community detection algorithm is used to partition the wireless network into the groups, where the community detection algorithm takes the proximity indicating information as input, and wherein communities found by the community detection algorithm define the groups.

7. The method according to claim 5, wherein the wireless network is partitioned into the groups of APs in accordance with an undirected graph constructed from the connectivity matrix.

8. The method according to claim 1, wherein the roles are assigned in each of the groups, to have as many APs assigned to the transmitting role as assigned to the receiving role.

9. The method according to claim 1, wherein the roles are assigned, in each of the groups, to optimize a communication metric for communication between the APs and the passive wireless backscattering devices.

10. The method according to claim 9, wherein the communication metric pertains to diversity order of a radio propagation channel between the APs and the passive wireless backscattering devices.

11. The method according to claim 5, wherein each group corresponds to a respective sub-matrix of the connectivity matrix, and wherein the roles for a given group of APs are assigned as a function of entries of the sub-matrix for said given group of APs.

12. The method according to claim 1, wherein, for each of the groups of APs, the APs assigned the transmitting role are instructed by the controller to jointly transmit a matrix-valued signal.

13. (canceled)

14. The method according to claim 1, wherein the controller configures the APs in each group of APs to communicate with the passive wireless backscattering devices using distinct orthogonal signaling resources.

15. The method according to claim 1, wherein the controller configures the APs in each group of APs to communicate with the passive wireless backscattering devices using distinct non-orthogonal signaling resources.

16. The method according to claim 1, wherein the wireless network is partitioned into at least two groups of APs, and wherein the controller configures the APs in one of the at least two groups of APs to communicate with the passive wireless backscattering devices independently of the APs in any other of the at least two groups of APs.

17. The method according to claim 1, wherein the wireless network is partitioned into at least two groups of APs, and wherein the controller configures the APs such that, when at least one of the APs in one of the at least two groups of APs is communicating with the passive wireless backscattering devices in the transmitting role, all APs in at least one other of the at least two groups of APs are communicating with the passive wireless backscattering devices in the receiving role.

18. The method according to claim 1, wherein the controller configures the APs to switch between the transmitting role and the receiving role and vice versa within each of the groups between two consecutive communication instances.

19. The method according to claim 1, wherein the controller configures each of the APs to communicate using transmit beams and receive beams, and wherein the transmit beams and the receive beams are determined based on measurements of signals for sounding communication between the APs, as backscattered by the passive wireless backscattering devices.

20. The method according to claim 1, wherein the controller configures each of the APs to communicate using transmit beams and receive beams defined by a grid-of-beams, and wherein the controller configures the APs to communicate with the passive wireless backscattering devices by sounding different combinations of pairs of the transmit beams and the receive beams.

21. (canceled)

22. A controller for communicating with passive wireless backscattering devices, the controller being configured to control access points, APs, in a wireless network, the controller comprising processing circuitry-, the processing circuitry being configured to cause the controller to:
partition the wireless network into groups of APs according to proximity indicating information of the APs, the proximity indicating information indicating how proximate the APs are relative each other;
assign, to the APs in each of the groups, either a transmitting role or a receiving role for communicating with the passive wireless backscattering devices, at least one AP in each group being assigned the transmitting role and at least one other AP in each group is assigned the receiving role; and
initiate the APs to communicate with the passive wireless backscattering devices in accordance with the assigned roles.

23.-26. (canceled)
